(19) United States
(12) Patent Application Publication
(10) Pub. No.: US 2025/0299308 A1
(43) Pub. Date: Sep. 25, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: TATSUYA YAMAMOTO, Tokyo (JP); MASAFUMI TAKIMOTO, Kanagawa (JP); ATSUSHI NOGAMI, Kanagawa (JP)

(21) Appl. No.: 19/230,778

(22) Filed: Jun. 6, 2025

Related U.S. Application Data
(63) Continuation of application No. PCT/JP2023/042133, filed on Nov. 24, 2023.

(30) Foreign Application Priority Data
Dec. 8, 2022 (JP) 2022-196117

(51) Int. Cl. G06T 5/80; G06T 5/50

(52) U.S. Cl. CPC G06T 5/80; G06T 5/50; G06T 2207/20221

(57) ABSTRACT

An information processing apparatus includes a first acquisition unit configured to acquire a first image in which a detection object is captured, and a distance to the detection object in the first image, a second acquisition unit configured to acquire a second image, a first generation unit configured to deform the second image based on the distance to the detection object in the first image, and generate a combined image based on the first image and the deformed second image, and a second generation unit configured to generate training data by using the combined image.

### CROSS-REFERENCE TO RELATED APPLICATIONS

This application is a Continuation of International Patent Application No. PCT/JP2023/042133, filed Nov. 24, 2023, which claims the benefit of Japanese Patent Application No. 2022-196117, filed Dec. 8, 2022, both of which are hereby incorporated by reference herein in their entirety.

### BACKGROUND OF THE INVENTION

### Field of the Invention

The present invention relates to an information processing apparatus, an information processing method, and a storage medium.

### Background Art

In recent years, in an agricultural field, to grasp a condition of a farm such as occurrence of a disease and a growth condition, a method of detecting a predetermined detection object such as a dead branch and a bunch from an image captured by a camera mounted on a vehicle, and examining the predetermined detection object is considered. In such a method, to detect the detection object, a detector that has been trained by a machine learning method using, as training data, information on an object area indicating an area of the detection object previously manually imparted to an image is generally used.

Patent Literature 1 discusses a method of preparing training data by imparting a rectangle indicating an object area and a label to an image, and training a neural network as a detector.

### CITATION LIST

### Patent Literature

PTL 1: Japanese Unexamined Patent Application Publication (Translation of PCT Application) No. 2020-532008

However, some agricultural products are planted in hedge rows. When the agricultural products planted in a specific hedge are examined, the hedge that is not the target of examination appears as a background in an image. If a result detected from the hedge not to be examined is used, an erroneous examination result is obtained. Therefore, even when the detection object is in an image, the detection object is desirably not detected from the hedge that is not the target of examination.

To cope with the situation, it is necessary to prepare, as the training data, an image in which the hedge appears as the background, and to perform training without using the background hedge as the object area. However, how the hedge appears in the image depends on a plurality of conditions such as an angle of the camera and widths of the hedges. Thus, there are a large variety of backgrounds. Therefore, a large amount of training data is necessary, and it takes time and effort to generate the training data.

### SUMMARY OF THE INVENTION

The present invention is directed to a technique for easily generating training data using a variety of images.

According to an aspect of the present invention, an information processing apparatus includes a first acquisition unit configured to acquire a first image in which a detection object is captured, and a distance to the detection object in the first image, a second acquisition unit configured to acquire a second image, a first generation unit configured to deform the second image based on the distance to the detection object in the first image, and generate a combined image based on the first image and the deformed second image, and a second generation unit configured to generate training data by using the combined image.

Further features of the present invention will become apparent from the following description of exemplary embodiments with reference to the attached drawings.

### BRIEF DESCRIPTION OF THE DRAWINGS

FIG. 1 is a diagram illustrating an example of a hardware configuration of an information processing apparatus.

FIG. 2 is a diagram illustrating an example of a functional configuration of the information processing apparatus.

FIG. 3 is a diagram illustrating an example of a table for managing a label of a detection object.

FIG. 4 is a diagram illustrating an example of a table for managing information on an object image.

FIG. 5 is a flowchart illustrating exemplary operation for generating training data.

FIG. 6 is a diagram illustrating an example of a state where cameras are installed on both sides of a vehicle.

FIG. 7 is a diagram illustrating an example of a state where the vehicle travels through spaces among hedges.

FIG. 8 is a diagram illustrating examples of an object image, an object area, and a distance map.

FIG. 9 is a diagram illustrating examples of a combined image obtained by combining a background image with the object image.

FIG. 10 is a flowchart illustrating exemplary operation for generating training data.

### DESCRIPTION OF THE EMBODIMENTS

Some preferred exemplary embodiments will be described in detail below with reference to drawings. Note that configurations described in the following exemplary embodiments are merely illustrative, and the present invention is not limited to the illustrated configurations.

### First Exemplary Embodiment

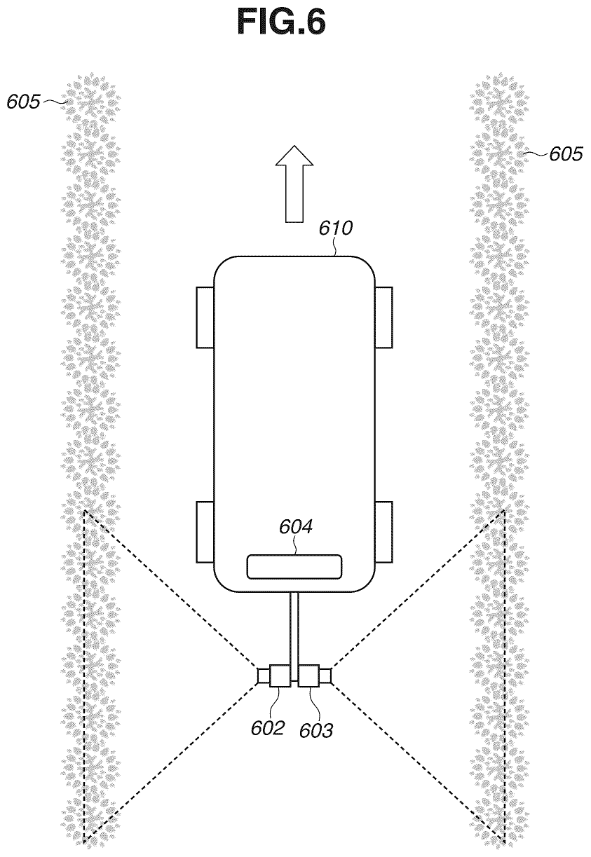

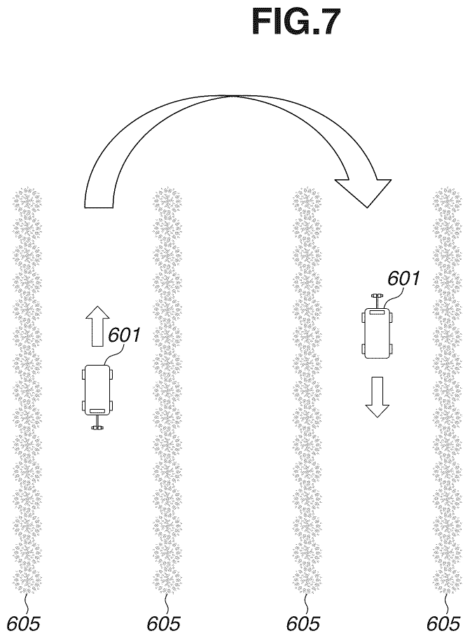

FIG. 6 is a diagram illustrating a state where a left camera 602 and a right camera 603 are installed on both sides of a vehicle 601 to perform imaging. FIG. 7 is a diagram illustrating a state where the vehicle 601 travels through spaces among hedges 605 while skipping every other space. In an agricultural field, to grasp a condition of a farm such as occurrence of a disease and a growth condition, a predetermined detection object such as a dead branch and a bunch is detected from images captured by the left camera 602 and the right camera 603 mounted on the vehicle 601, and is examined.

In a first exemplary embodiment, a farm growing grapes for wine as agricultural products is described as an example. The grapes for wine are generally managed in sections based on breeds and tree ages. In each section, fruit trees are planted and grown in a plurality of hedge rows (hedge is also referred to as a row). The vehicle 601 includes an imaging control apparatus 604, travels through spaces among the hedges 605, and performs imaging by using the left camera 602 and the right camera 603 installed on both sides of the vehicle 601. The vehicle 601 travels through the spaces among the hedges 605 while skipping every other space so as not to repeatedly image the same tree.

A method of generating training data for detecting a branch, a dead branch, and a trunk as detection objects from the grape trees for wine imaged in the above-described manner will be described. The detection objects are illustrative, and other items such as a bunch and a picket may be regarded as the detection objects. Further, the detection objects are not limited to the hedges of the grape trees, and may be a person, a vehicle, and the like as long as the purpose is to distinguish and detect a certain row from rows to be examined.

### <Hardware Configuration>

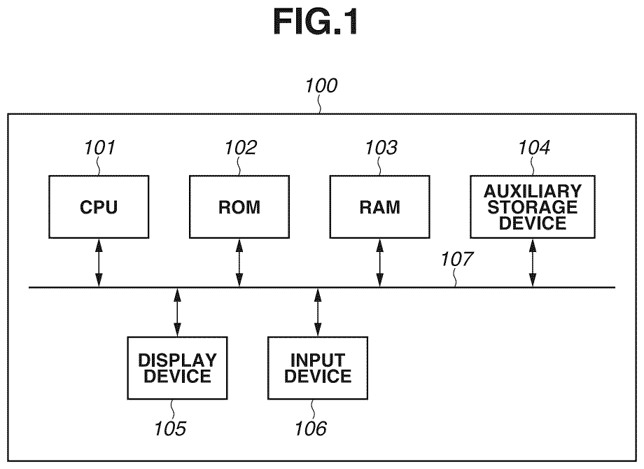

FIG. 1 is a diagram illustrating an example of a hardware configuration of an information processing apparatus 100 according to the first exemplary embodiment. The information processing apparatus 100 includes a central processing unit (CPU) 101, a read only memory (ROM) 102, a random access memory (RAM) 103, an auxiliary storage device 104, a display device 105, an input device 106, and a system bus 107.

The CPU 101 performs calculation for various kinds of processing, logical determination, and the like, and controls components connected to the system bus 107. The ROM 102 is a program memory, and stores programs including various kinds of processing procedures described below for control by the CPU 101.

The RAM 103 is used as a temporary storage area such as a main memory and a work area for the CPU 101. The CPU 101 reads the programs stored in the ROM 102 and executes the programs, thereby realizing processing based on flowcharts described below. The programs stored in the ROM 102 may be loaded to the RAM 103 to implement the program memory. The CPU 101 writes execution results of the processing in the RAM 103.

The auxiliary storage device 104 is a storage device that stores electronic data and programs according to the present exemplary embodiment and retains the stored data even after power-off. The auxiliary storage device 104 can be realized by, for example, a medium (recording medium) and an external storage drive for realizing access to the medium. Examples of such a medium include a flash memory, a universal serial bus (USB) memory, a solid state drive (SSD) memory, a hard disk drive (HDD), a flexible disk (FD), a compact disk (CD)-ROM, a digital versatile disk (DVD), and a memory card. The auxiliary storage device 104 may be, for example, a server apparatus connected through a network. The auxiliary storage device 104 may be, for example, a built-in SSD memory, and may be undetachable from the CPU 101. In the present exemplary embodiment, a case where the auxiliary storage device 104 is a built-in SSD memory and a memory card for capturing data from outside will be described below. The program memory may be implemented by loading the programs stored in the auxiliary storage device 104 to the RAM 103. The CPU 101 stores the execution results of the processing in the auxiliary storage device 104.

The display device 105 is, for example, a liquid crystal display or an organic electroluminescence (EL) display, and is a device outputting images, characters, and figures on a display screen by the processing of the CPU 101. The display device 105 may be an external device connected to the information processing apparatus 100 by wire or wirelessly.

The input device 106 is, for example, a touch panel, a button, or a mouse, and receives various kinds of operation by a user. The input device 106 may be a pressure touch panel or an electrostatic touch panel that is attached to the display device 105 and senses user operation, a light pen, or the like. The input device 106 may be an external device such as a mouse, connected to the information processing apparatus 100 by wire or wirelessly.

### <Functional Configuration>

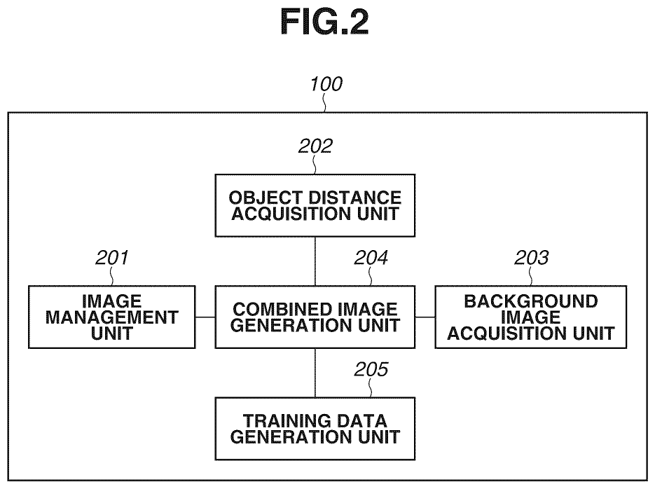

FIG. 2 is a block diagram illustrating an example of a functional configuration of the information processing apparatus 100 according to the first exemplary embodiment. Functional units illustrated in FIG. 2 are implemented when the CPU 101 loads the programs stored in the ROM 102 to the RAM 103, and performs processing described below. For example, in a case where hardware is configured as a substitute for software processing using the CPU 101, a calculation unit or a circuit corresponding to the processing of each functional unit described here nay be configured. In the following, each element is described.

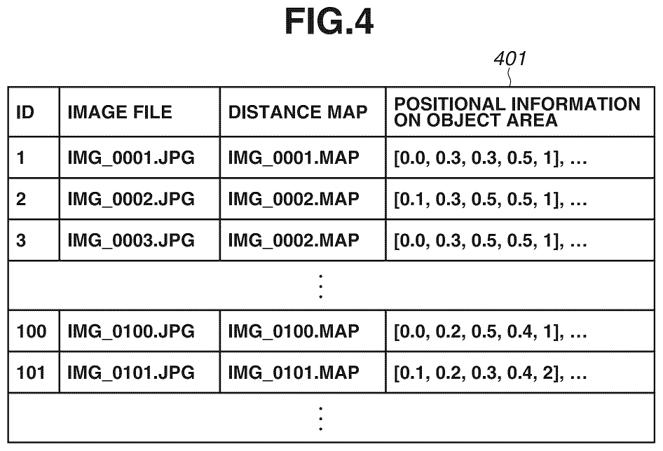

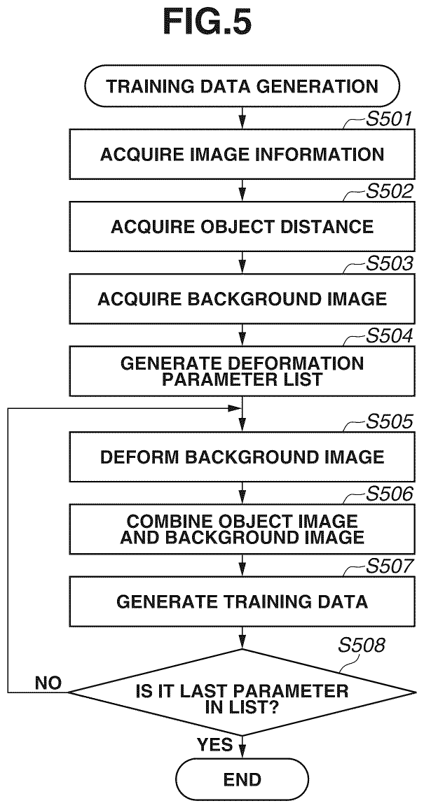

The information processing apparatus 100 includes an image management unit 201, an object distance acquisition unit 202, a background image acquisition unit 203, a combined image generation unit 204, and a training data generation unit 205. The image management unit 201 manages an image file of an object image in which a detection object is captured, information on an object area indicating an area of the detection object, and the like, by using an image management table 401 illustrated in FIG. 4 described below. The object distance acquisition unit 202 acquires an object distance which is a distance to the detection object. The background image acquisition unit 203 acquires a background image. The combined image generation unit 204 deforms the background image based on the object distance, and generates a combined image of the object image and the background image, based on a flowchart in FIG. 5 described below. Deformation is image processing such as enlargement/reduction and parallel movement. The training data generation unit 205 generates training data by using the combined image and positional information on the object area.

### <Flow of Processing>

In the present exemplary embodiment, a flow of processing by the information processing apparatus 100 for combining information on hedges and an image, and displaying a resultant image will be described.

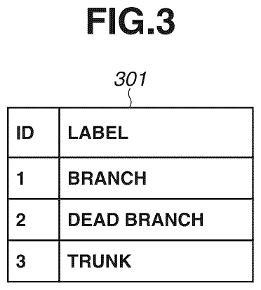

FIG. 3 is a diagram illustrating an example of a label management table 301 for managing a label of the detection object. The label management table 301 includes a label and an identification (ID) of the label. The label indicates what an area of the detection object is. In this example, a branch, a dead branch, and a trunk are detection objects.

FIG. 4 is a diagram illustrating an example of the image management table 401 for managing information on the object image in which the detection object is captured, as a source of the training data. The image management table 401 includes an ID of an image, an image file name, a file name of a distance map, and positional information on the object area in the object image. The distance map is a file where a numerical value indicating a distance to the object in each pixel of the object image is recorded, and is output from the camera at the time of imaging. The positional information on the object area is an array in which XY coordinates of an upper left vertex and a lower right vertex of a rectangle indicating the detection object, and the ID of the label are arranged, and is recorded as many as the number of detection objects to be detected. The detection object is desirably not detected from the background. Therefore, positional information on the object area only for a foreground portion to be examined is registered.

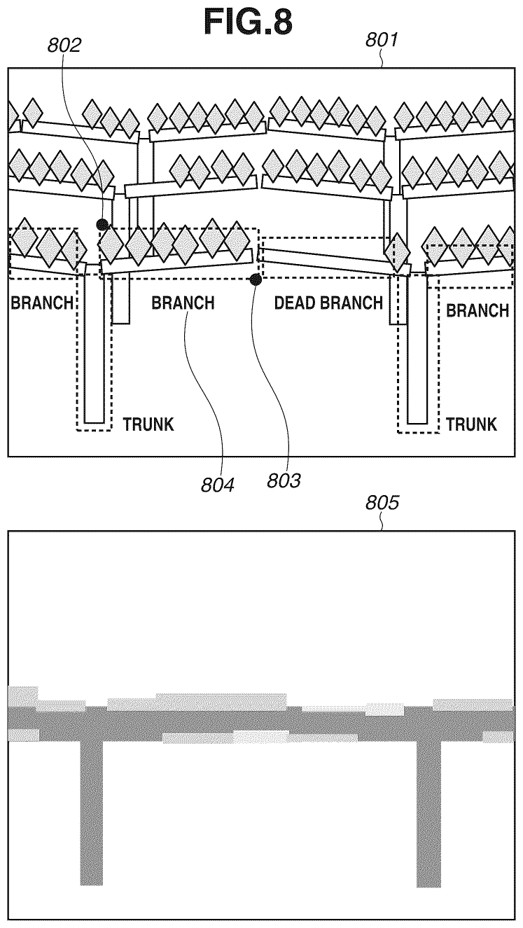

FIG. 8 is a diagram illustrating examples of an object image 801, an object area, and a distance map 805. In the object image 801, an upper left vertex 802 (having XY coordinates of 0.2 and 0.4) of the object area and a lower right vertex 803 (having XY coordinates of 0.5 and 0.5) of the object area are illustrated. In the object image 801, a label 804 (having label ID of 1) is assigned to the object area. In the object image 801, six object areas are illustrated by broken-line rectangles. Six arrays each of which including five numerical values, i.e., the XY coordinates of the upper left vertex and the lower right vertex of the object area, and the label ID are registered as the positional information on the object areas in the image management table 401 illustrated in FIG. 4.

An image 805 indicates the distance map in the form of an image, and a pixel having deeper color indicates the smaller distance. A resolution of the distance map 805 may be equal to or lower than a resolution of the object image 801.

FIG. 5 is a flowchart illustrating processing for generating training data by deforming the background image based on the object distance, and combining the object image and the background image. The agricultural products are planted in rows of the hedges 605. When the agricultural products planted in a specific hedge 605 are examined, the hedge 605 that is not the target of examination appears as the background in an image. If a result detected from the hedge 605 that is not the target of examination is used, an erroneous examination result is obtained. Therefore, even when the detection object is in the image, the detection object is desirably not detected from the hedge 605 that is not the target of examination. To cope with the situation, it is necessary to prepare, as the training data, an image in which the hedge 605 appears as the background, and to perform training without using the background hedge 605 as the object area. However, how the hedge 605 appears in the image depends on a plurality of conditions such as an angle of the camera and intervals of the plurality of rows of the hedges 605. Thus, there are a large variety of backgrounds. Therefore, a large amount of training data is necessary, and it takes time and effort to generate the training data. The present exemplary embodiment is made to solve the issue.

The flowchart in FIG. 5 illustrates processing for generating training data with a plurality of backgrounds, from one designated object image. By repeatedly designating a plurality of object images and performing the processing in the flowchart, a large amount of training data is generated. A processing method by the information processing apparatus 100 will be described below.

In step S501, the image management unit 201 acquires information on the object image 801 having the designated image ID from the image management table 401. More specifically, the image management unit 201 functions as an acquisition unit, and acquires an object image in which the detection object is captured (image file name), the distance map of the object image, and the positional information on the detection object (object area) in the object image, from the image management table 401.

In step S502, the object distance acquisition unit 202 acquires an object distance to the detection object in the object image. The object distance may be calculated by acquiring, from the distance map 805, distances to the object in the respective pixels in all object areas of the object image, and calculating an average value of the distances, or based on previously-registered information on intervals of the plurality of rows of the hedges (detection objects) 605. Alternatively, the object distance acquisition unit 202 may calculate the object distance based on a size of a rectangle of the object area (detection object).

In step S503, the background image acquisition unit 203 acquires a background image. The background image may be an image prepared for a background, or an image obtained by extracting only pixels having a long distance from the object image 801 based on the distance map 805. The background image is an image in which the detection object is captured.

In steps S504 to S506, the combined image generation unit 204 generates a combined image. In step S504, the combined image generation unit 204 generates a list of the predetermined number of deformation parameters based on the object distance acquired in step S502. The deformation parameters are obtained by quantifying an enlargement/reduction rate of the background image, and vertical/lateral parallel movement amounts of the background image. There is a tendency that the hedge 605 appearing as the background becomes far and a possible range of the background is widened as the object distance is increased. For this reason, the deformation parameters are set such that the background image is largely deformed as the object distance is large, and the background image is slightly deformed as the object distance is small. For example, the combined image generation unit 204 defines a range of the enlargement/reduction rate and a range of the parallel movement amount for each object distance, and randomly assigns a value within the range of the corresponding object distance to generate the deformation parameters. This makes it possible to prevent the combined image generation unit 204 from generating an image having an unrealistic background. When the object distance is large and the possible range is wide, the number of deformation parameters included in the list may be increased in order to cover the range to some extent.

In step S505, the combined image generation unit 204 acquires one unprocessed deformation parameter from the above-described list, and deforms the background image acquired in step S503 based on the deformation parameter. Based on the deformation parameter, the combined image generation unit 204 largely deforms the background image as the distance to the detection object in the object image is larger, and slightly deforms the background image as the distance to the detection object in the object image is smaller.

In step S506, the combined image generation unit 204 generates a combined image based on the background image deformed in step S505 and the object image acquired in step S501. To combine the object image and the background image, the combined image generation unit 204 extracts only the foreground area having a small distance from the object image by using the distance map 805, and combines the extracted foreground area and the background image. The number of hedges to be combined as the background is not limited to one, and two hedges, for example, hedges in a second row and a third row may be combined as the background. In this case, the combined image generation unit 204 generates the deformation parameter lists in step S504 by the necessary number of hedges, for example, generates a deformation parameter list for the second row and a deformation parameter list for the third row.

In step S507, the training data generation unit 205 generates one piece of training data by associating the generated combined image and the positional information on the object area in the object image.

In step S508, the combined image generation unit 204 determines whether processing has been performed up to a last deformation parameter in the deformation parameter list. In a case where processing has not been performed up to the last deformation parameter (NO in step S508), the processing returns to step S505, and a plurality of pieces of training data is generated from one object image. In a case where processing has been performed up to the last deformation parameter (YES in step S508), the processing in the flowchart in FIG. 5 ends.

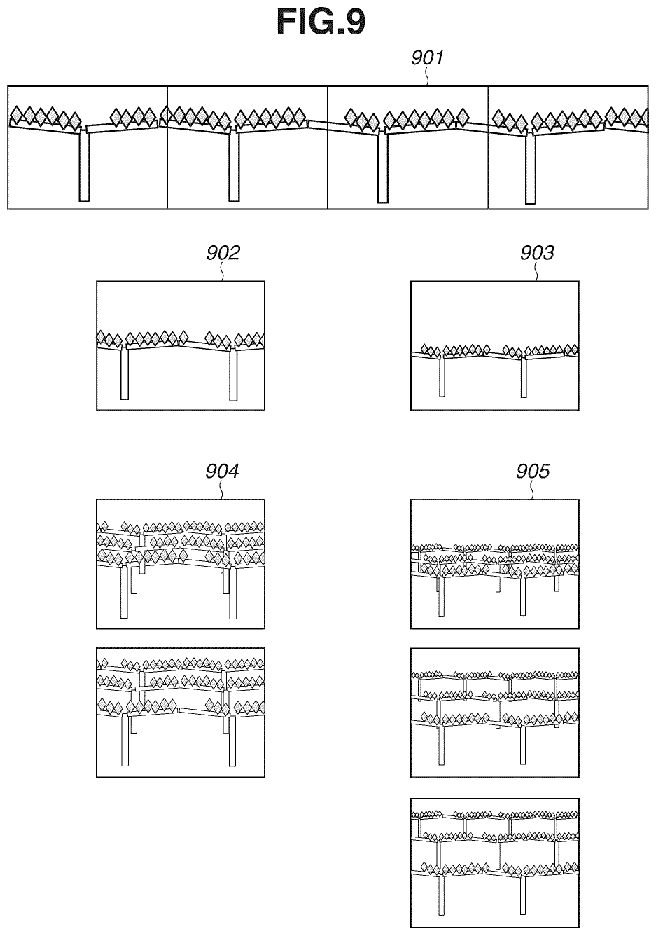

FIG. 9 is a diagram illustrating combined images that are obtained by deforming a prepared background image to a background image for the second row and a background image for the third row based on the object distance, and combining the deformed background images and the object images. In FIG. 9, a background image 901 before deformation is illustrated. In this example, the background image having a lateral width of four images is prepared in consideration of reduction. In FIG. 9, an object image 902 having a small object distance and an image 903 obtained by extracting a foreground from the object image having a large object distance are illustrated. Combined images 904 and 905 are obtained by combining the deformed background images and the object images. In the combined images 905 having the large object distance, the background image deformed such that the background is further reduced and vertically moved as compared with the background of the combined images 904 having the small object distance is combined. The combined images 905 having the large object distance is wide in possible range of the hedges appearing as the background in vertical parallel movement.

Therefore, the number of generated combined images 905 is greater by one than the number of generated combined images 904.

The combined image generation unit 204 deforms the background image at the plurality of different deformation rates (deformation parameters) based on the distance to the detection object in the object image, and generates a plurality of combined images obtained by combining the object image and the background images deformed at the plurality of deformation rates. In a case where the distance to the detection object in the object image is large, the combined image generation unit 204 generates more combined images than in a case where the distance to the detection object in the object image is small. The training data generation unit 205 generates a plurality of pieces of training data by using the plurality of combined images.

According to the first exemplary embodiment described above, only by preparing the object image and the positional information on the object area, it is possible to generate a large amount of training data having a variety of backgrounds considered so as not to be unrealistic backgrounds, based on the object distance.

In the present exemplary embodiment, the combined image generation unit 204 generates the combined images based on one background image prepared in advance; however, a plurality of background images may be prepared, and the combined images may be generated using a randomly selected background image.

When the agricultural products planted in a plurality of hedge rows are examined, the hedge that is not the target of examination appears as a background in an image. If a result detected from the hedge that is not the target of examination is used, an erroneous examination result is obtained. Therefore, even when the detection object is in the image, the detection object is desirably not detected from the hedge that is not the target of examination. To cope with the situation, it is necessary to prepare, as the training data, an image in which the hedge appears as the background, and to perform training without using the background hedge as the object area. According to the present exemplary embodiment, the information processing apparatus 100 can easily generate the training data having a variety of backgrounds.

In the first exemplary embodiment, the prepared background image is variously deformed, and the training data is generated by combining the deformed background image and the object image. However, to increase variations of the background image itself, it is necessary to prepare a large number of background images in advance. In a second exemplary embodiment, by using another object image as the background image, the training data having a variety of backgrounds is generated without preparing the background image in advance.

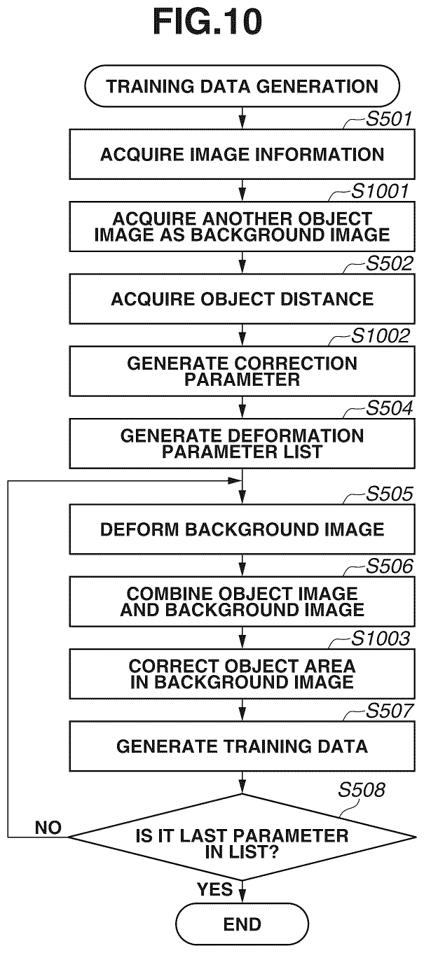

FIG. 10 is a flowchart of processing changed from the processing in the flowchart in FIG. 5 such that another object image is acquired as the background image, and the background image is deformed and combined.

In step S501, the image management unit 201 acquires information on the object image 801 having the designated image ID from the image management table 401. More specifically, the image management unit 201 functions as an acquisition unit, and acquires an object image in which the detection object is captured (image file name), the distance map of the object image, and the positional information on the detection object (object area) in the object image, from the image management table 401.

In step S1001, the background image acquisition unit 203 randomly acquires, from the image management table 401, information on an image having an image ID other than the object image acquired in step S501, and determines the acquired information on the image as information on the background image. More specifically, the background image acquisition unit 203 acquires a background image in which the detection object is captured (image file name), the distance map of the background image, and the positional information on the detection object (object area) in the background image, from the image management table 401. As the information on the background image to be acquired, information on a plurality of images may be acquired as in the case of the background image 901 illustrated in FIG. 9, in consideration of reduction.

In step S502, as in FIG. 5, the object distance acquisition unit 202 acquires an object distance to the detection object in the object image based on the information on the object image acquired in step S501. Likewise, the object distance acquisition unit 202 acquires an object distance to the detection object in the background image based on the information on the background image acquired in step S1001.

In step S1002, the combined image generation unit 204 generates a correction parameter for correcting the background image to a predetermined size based on the object distance to the detection object in the background image. A size of a grape tree in the image is different between a case where the object distance in the background image is small and a case where the object distance in the background image is large. Therefore, when the deformation parameter is simply applied in a manner similar to the flowchart in FIG. 5, the size of the grape tree may become an unrealistic size. When the combined image generation unit 204 performs correction using the correction parameter such that the size of the grape tree in the background image becomes the predetermined size, the issue can be avoided.

In step S504, in a manner similar to the flowchart in FIG. 5, the combined image generation unit 204 generates a deformation parameter list, and corrects the deformation parameter list with the correction parameter.

In steps S505 and S506, the combined image generation unit 204 performs processing similar to the processing in the flowchart in FIG. 5. However, the combined image generation unit 204 causes the training data generated in step S507 to include the positional information on the object area not only in the object image but also in the background image. The combined image generation unit 204 deforms the background image based on the distance to the detection object in the object image and the distance to the detection object in the background image, and generates a combined image based on the object image and the deformed background image.

In step S1003, the combined image generation unit 204 corrects the positional information on the object area in the background image in a manner similar to the background image based on the corrected deformation parameter, and changes the label to a label for the background image. In other words, the combined image generation unit 204 corrects the positional information on the detection object in the background image, based on the deformation parameter based on the distance to the detection object in the object image, and the correction parameter based on the distance to the detection object in the background image. For example, the combined image generation unit 204 changes a “dead branch” to a “dead branch (background)” or a “dead branch (second row)”. This enables training such that the detection object is distinguished and detected from the background image. In a case where detection is unnecessary, the combined image generation unit 204 may delete and exclude the positional information on the object area in the background image from the training data.

In step S507, the training data generation unit 205 generates one piece of training data by associating the generated combined image, the positional information on the object area in the object image, and the positional information on the object area in the corrected background image. The training data generation unit 205 may generate one piece of training data by associating the generated combined image with the positional information on the object area in the object image.

In step S508, the combined image generation unit 204 determines whether processing has been performed up to a last deformation parameter in the deformation parameter list. In a case where processing has not been performed up to the last deformation parameter (NO in step S508), the processing returns to step S505, and a plurality of pieces of training data is generated from one object image. In a case where processing has been performed up to the last deformation parameter (YES in step S508), the processing in the flowchart in FIG. 10 ends.

According to the second exemplary embodiment described above, the information processing apparatus 100 uses another object image as the background image. Therefore, the information processing apparatus 100 can generate training data having a variety of backgrounds without preparing the background image in advance.

To increase the variations of the background, the processing in the flowchart in FIG. 10 may be performed using the same image ID a plurality of times. Further, when another object image is acquired in step S1001, another object image may be acquired with a plurality of patterns, and the processing in steps S502 to S508 may be repeated.

Further, in actual detection, a case where a tree age of the grape tree on the foreground and a tree age of the grape tree on the background are largely different is not realistic. Therefore, when another object image is acquired in step S1001, an object image close in attribute such as the tree age to the object image acquired in step S501 may be acquired.

Further, when the deformation parameter is generated in step S504, deformation may be performed in consideration of the size and the position of the object area after the deformation in addition to the information on the object distance, so as not to obtain an unrealistic background.

### OTHER EXEMPLARY EMBODIMENT

Although the exemplary embodiments are described above, the present invention can also be embodied as, for example, a system, an apparatus, a method, a program, or a recording medium (storage medium). More specifically, the present invention may also be applied to a system including a plurality of devices (e.g., host computer, interface device, imaging apparatus, and web application), or may also be applied to an apparatus including one device.

The present invention can be implemented by supplying a program realizing one or more functions of the above-described exemplary embodiments to a system or an apparatus through a network or a storage medium, and causing one or more processors in a computer of the system or the apparatus to read out and execute the program. Further, the present invention can be implemented by a circuit (e.g., application specific integrated circuit (ASIC)) realizing one or more functions.

The above-described exemplary embodiments are merely specific examples for implementing the present invention, and the technical scope of the present invention should not be interpreted limitedly by the exemplary embodiments. In other words, the present invention can be implemented in various forms without departing from the technical idea or the main feature of the present invention.

For example, the detection object may be a deformation such as a crack occurring on a surface of an industrial product, a moving body such as a passenger plane, or a structure (concrete structure) such as a bridge and a building, in addition to the agricultural products.

The disclosure of the exemplary embodiments includes configurations, a method, and a program described below.

### (Configuration 1)

An information processing apparatus including:
a first acquisition unit configured to acquire a first image in which a detection object is captured, and a distance to the detection object in the first image;
a second acquisition unit configured to acquire a second image;
a first generation unit configured to deform the second image based on the distance to the detection object in the first image, and generate a combined image based on the first image and the deformed second image; and
a second generation unit configured to generate training data by using the combined image.

### (Configuration 2)

The information processing apparatus according to configuration 1, in which the first acquisition unit acquires the distance to the detection object based on information on distances to an object in respective pixels of the first image, intervals of a plurality of rows of the detection object, or a size of the detection object.

### (Configuration 3)

The information processing apparatus according to configuration 1 or 2, in which the first generation unit largely deforms the second image as the distance to the detection object in the first image is larger, and slightly deforms the second image as the distance to the detection object in the first image is smaller.

### (Configuration 4)

The information processing apparatus according to any one of configurations 1 to 3,
in which the first generation unit deforms the second image at a plurality of different deformation rates based on the distance to the detection object in the first image, and generates a plurality of combined images by combining the first image and the second images deformed at the plurality of deformation rates, and
in which the second generation unit generates a plurality of pieces of training data by using the plurality of combined images.

### (Configuration 5)

The information processing apparatus according to configuration 4, in which, in a case where the distance to the detection object in the first image is large, the second generation unit generates more combined images than in a case where the distance to the detection object in the first image is small.

### (Configuration 6)

The information processing apparatus according to any one of configurations 1 to 5, in which the second image is an image in which the detection object is captured.

### (Configuration 7)

The information processing apparatus according to any one of configurations 1 to 6,
in which the second acquisition unit acquires the second image in which the detection object is captured, and a distance to the detection object in the second image, and
in which the second acquisition unit deforms the second image based on the distance to the detection object in the first image and the distance to the detection object in the second image, and generates the combined image based on the first image and the deformed second image.

### (Configuration 8)

The information processing apparatus according to any one of configurations 1 to 7,
in which the first acquisition unit acquires the first image in which the detection object is captured, the distance to the detection object in the first image, and positional information on the detection object in the first image, and
in which the second generation unit generates the training data by using the combined image and the positional information on the detection object in the first image.

### (Configuration 9)

The information processing apparatus according to configuration 7,
in which the first acquisition unit acquires the first image in which the detection object is captured, the distance to the detection object in the first image, and positional information on the detection object in the first image,
in which the second acquisition unit acquires the second image in which the detection object is captured, the distance to the detection object in the second image, and positional information on the detection object in the second image,
in which the second generation unit corrects the positional information on the detection object in the second image based on the distance to the detection object in the first image and the distance to the detection object in the second image, and
in which the second generation unit generates the training data by using the combined image, the positional information on the detection object in the first image, and the corrected positional information on the detection object in the second image.

### (Method 1)

An information processing method including:
acquiring a first image in which a detection object is captured, and a distance to the detection object in the first image;
acquiring a second image;
deforming the second image based on the distance to the detection object in the first image, and generating a combined image based on the first image and the deformed second image; and
generating training data by using the combined image.

### (Program 1)

A program causing a computer to function as the information processing apparatus according to any one of configurations 1 to 9.

The present invention is not limited to the above-described exemplary embodiments, and can be variously changed and modified without departing from the spirit and the scope of the present invention. Therefore, to apprise the public of the scope of the present invention, the following claims are made.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to easily generate training data using a variety of images.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising:
a first acquisition unit configured to acquire a first image in which a detection object is captured, and a distance to the detection object in the first image;
a second acquisition unit configured to acquire a second image;
a first generation unit configured to deform the second image based on the distance to the detection object in the first image, and generate a combined image based on the first image and the deformed second image; and
a second generation unit configured to generate training data by using the combined image.

2. The information processing apparatus according to claim 1, wherein the first acquisition unit acquires the distance to the detection object based on information on distances to an object in respective pixels of the first image, intervals of a plurality of rows of the detection object, or a size of the detection object.

3. The information processing apparatus according to claim 1, wherein the first generation unit largely deforms the second image as the distance to the detection object in the first image is larger, and slightly deforms the second image as the distance to the detection object in the first image is smaller.

4. The information processing apparatus according to claim 1,
wherein the first generation unit deforms the second image at a plurality of different deformation rates based on the distance to the detection object in the first image, and generates a plurality of combined images by combining the first image and the second images deformed at the plurality of deformation rates, and
wherein the second generation unit generates a plurality of pieces of training data by using the plurality of combined images.

5. The information processing apparatus according to claim 4, wherein, in a case where the distance to the detection object in the first image is large, the second generation unit generates more combined images than in a case where the distance to the detection object in the first image is small.

6. The information processing apparatus according to claim 1, wherein the second image is an image in which the detection object is captured.

7. The information processing apparatus according to claim 1,
wherein the second acquisition unit acquires the second image in which the detection object is captured, and a distance to the detection object in the second image, and
wherein the second acquisition unit deforms the second image based on the distance to the detection object in the first image and the distance to the detection object in the second image, and generates the combined image based on the first image and the deformed second image.

8. The information processing apparatus according to claim 1,
wherein the first acquisition unit acquires the first image in which the detection object is captured, the distance to the detection object in the first image, and positional information on the detection object in the first image, and
wherein the second generation unit generates the training data by using the combined image and the positional information on the detection object in the first image.

9. The information processing apparatus according to claim 7,
wherein the first acquisition unit acquires the first image in which the detection object is captured, the distance to the detection object in the first image, and positional information on the detection object in the first image,
wherein the second acquisition unit acquires the second image in which the detection object is captured, the distance to the detection object in the second image, and positional information on the detection object in the second image,
wherein the second generation unit corrects the positional information on the detection object in the second image based on the distance to the detection object in the first image and the distance to the detection object in the second image, and
wherein the second generation unit generates the training data by using the combined image, the positional information on the detection object in the first image, and the corrected positional information on the detection object in the second image.

10. An information processing method comprising:
acquiring a first image in which a detection object is captured, and a distance to the detection object in the first image;
acquiring a second image;
deforming the second image based on the distance to the detection object in the first image, and generating a combined image based on the first image and the deformed second image; and
generating training data by using the combined image.

11. A non-transitory computer-readable storage medium storing a program for causing a computer to perform a method for controlling an information processing apparatus, the method comprising:
acquiring a first image in which a detection object is captured, and a distance to the detection object in the first image;
acquiring a second image;
deforming the second image based on the distance to the detection object in the first image, and generating a combined image based on the first image and the deformed second image; and
generating training data by using the combined image.
